(19) United States
(12) Patent Application Publication
(10) Pub. No.: US 2026/0087966 A1
(43) Pub. Date: Mar. 26, 2026

(54) DISPLAY APPARATUS

(71) Applicant: LG DISPLAY CO., LTD., Seoul (KR)

(72) Inventor: Sunghoon KIM, Paju-si (KR)

(73) Assignee: LG DISPLAY CO., LTD., Seoul (KR)

(21) Appl. No.: 19/310,009

(22) Filed: Aug. 26, 2025

(30) Foreign Application Priority Data
Sep. 23, 2024 (KR) 10-2024-0128036

(51) Int. Cl. G09G 3/20; G06F 3/01

(52) U.S. Cl. CPC G09G 3/2092; G06F 3/013; G09G 2310/0286; G09G 2310/0297; G09G 2320/0209; G09G 2320/103; G09G 2330/021; G09G 2340/0435; G09G 2354/00; G09G 2370/10

(57) ABSTRACT

A display apparatus can include a display panel including pixels arranged in a plurality of horizontal lines, a camera configured to capture gaze of a user, a timing controller configured to receive source data and timing signals from a host system, receive gaze information from the camera, and generate first to third image data according to a degree of an amount of change in a gaze position, and a display driver. The display driver can receive the amount of change in the gaze position and the first to third image data and transmit one of the first to third image data to the display panel according to the amount of change in the gaze position of each of a plurality of horizontal lines.

### CROSS-REFERENCE TO RELATED APPLICATION

The present application claims priority to Korean Patent Application No. 10-2024-0128036, filed in the Republic of Korea on Sep. 23, 2024, the entire contents of which is expressly incorporated by reference into the present application.

### BACKGROUND OF THE INVENTION

### Field of the Invention

The present specification relates to a display apparatus.

### Description of the Related Art

As the information society develops, various demands for display apparatuses for displaying images are increasing, and various types of display apparatuses such as liquid crystal display (LCD) apparatuses and organic light emitting diode (OLED) display apparatuses are utilized.

Images displayed on a display apparatus can be still images or moving images, and the moving image can include various types such as sports images, game images, and movies. The display apparatus can include a plurality of pixels, and a plurality of switching elements for driving the pixels.

### SUMMARY OF THE INVENTION

The present disclosure is directed to providing a display apparatus in which it is possible to reduce crosstalk due to a latency between a time point at which a user's gaze is detected and a time point at which the synchronization of an image with a display panel is initiated.

The present disclosure is also directed to providing a display apparatus in which it is possible to improve a latency and reduce crosstalk, thereby improving reliability and reducing power consumption.

Objects of the present disclosure are not limited to the above-described objects, and other technical objects can be inferred from the following embodiments of the present disclosure.

According to one embodiment of the present disclosure, there is provided a display apparatus including a display panel including pixels arranged in a plurality of horizontal lines, a camera configured to capture a gaze of a user, a timing controller configured to receive source data and timing signals from a host system, receive gaze information from the camera, and generate first to third image data according to a degree of an amount of change in a gaze position, and a display driver configured to receive the amount of change in the gaze position and the first to third image data and transmit one of the first to third image data to the display panel according to the amount of change in the gaze position of each of a plurality of horizontal lines.

According to another embodiment of the present disclosure, there is provided a display apparatus including a display panel including pixels arranged in first and second horizontal lines, a camera configured to capture a gaze of a user, a timing controller configured to receive source data for an mth frame (m is a positive integer) from a host system, receive gaze information from the camera, and generate first to third image data for the mth frame according to a degree of an amount of change in a gaze position, and a display driver configured to receive the first to third image data at a start stage of the mth frame, receive an amount of change in a gaze position of the first horizontal line at a start stage of the first horizontal line, transmit one of the first to third image data to the display panel according to the amount of change in the gaze position of the first horizontal line, receive an amount of change in a gaze position of the second horizontal line at a start stage of the second horizontal line, and transmit one of the first to third image data to the display panel according to the amount of change in the gaze position of the second horizontal line.

Detailed matters of other embodiments of the present disclosure are included in the detailed description and accompanying drawings.

### BRIEF DESCRIPTION OF THE DRAWINGS

The present disclosure will become more fully understood from the detailed description given hereinbelow and the accompanying drawings which are given by way of illustration only, and thus are not limitative of the present disclosure.

FIG. 1 is a block diagram illustrating a display apparatus according to one or more embodiments of the present disclosure.

FIG. 2 is a view illustrating an operation conception of the display apparatus according to one embodiment of the present disclosure.

FIG. 3 is a view illustrating a user viewing an image in the display apparatus according to one embodiment of the present disclosure.

FIG. 4 is a block diagram illustrating a configuration that outputs image data based on gaze information of a user in the display apparatus according to one embodiment of the present disclosure.

FIG. 5 is a view illustrating a time delay of a displayed image based on the gaze information of the user in the display apparatus according to one embodiment of the present disclosure.

FIG. 6 is a block diagram illustrating the operation of the display apparatus according to one embodiment of the present disclosure.

FIG. 7 is a flowchart illustrating the operation of the display apparatus according to one embodiment of the present disclosure.

FIG. 8 is a flowchart illustrating a process of transmitting first to third image data in the display apparatus according to one embodiment of the present disclosure.

FIG. 9 is a flowchart illustrating a process of setting scaling of an amount of change in a gaze position in the display apparatus according to one embodiment of the present disclosure.

FIG. 10 is a view illustrating a data packet of the display apparatus according to one embodiment of the present disclosure.

FIG. 11 is a block diagram illustrating a display driver of the display apparatus according to one embodiment of the present disclosure.

FIG. 12 is a view illustrating a data selector of the display driver in the display apparatus according to one embodiment of the present disclosure.

FIG. 13 is a view illustrating an amount of change in a driving frequency based on gaze information of a user in a display apparatus according to another embodiment of the present disclosure.

FIG. 14 is a flowchart illustrating the operation of the display apparatus according to another embodiment of the present disclosure.

### DETAILED DESCRIPTION OF THE EMBODIMENTS

Hereinafter, embodiments of the present disclosure will be described with reference to the accompanying drawings. In the specification, in case that a first component (or an area, a layer, a portion, etc.) is described as “on,” “connected,” or “coupled to” a second component, it means that the first component can be directly connected/coupled to the second component or a third component can be disposed therebetween.

The same reference numerals indicate the same components. In addition, in the drawings, thicknesses, proportions, and dimensions of components are exaggerated for effective description of technical contents. The term “and/or” includes all one or more combinations that can be defined by the associated configurations.

Terms such as first and second can be used to describe various components, but the components are not limited by the terms. The terms are used only for the purpose of distinguishing one component from another. For example, a first component can be referred to as a second component, and similarly, the second component can also be referred to as the first component without departing from the scopes of the embodiments of the present disclosure. The singular includes the plural unless the context clearly dictates otherwise.

Terms such as “under,” “at a lower side,” “above,” and “at an upper side” are used to describe the relationship between the components illustrated in the drawings. The terms are relative concepts and are described with respect to directions marked in the drawings.

It should be understood that term such as “includes” or “has” is intended to specify the presence of features, numbers, steps, operations, components, parts, or a combination thereof described in the specification and does not preclude the presence or addition possibility of one or more other features, numbers, steps, operations, components, parts, or combinations thereof in advance. Further, the term “can” fully encompasses all the meanings and coverages of the term “may” and vice versa.

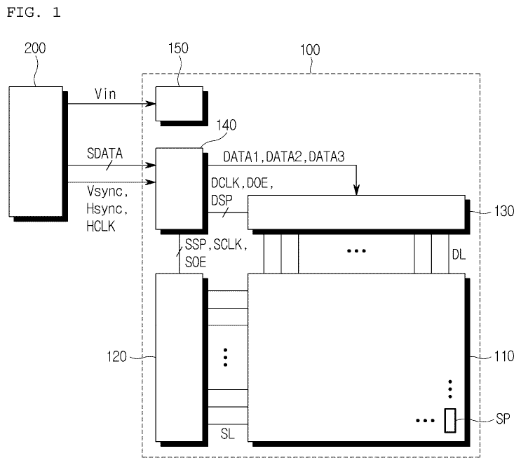

FIG. 1 is a block diagram illustrating a display apparatus according to one embodiment of the present disclosure.

Referring to FIG. 1, a display apparatus 100 can be applied to portable electronic devices, such as a mobile phone, a smart phone, a tablet personal computer (PC), a mobile communication terminal, an electronic notebook, an electronic book, a portable multimedia player (PMP), a navigation device, an ultra-mobile PC (UMPC), etc. For example, the display apparatus 100 can be applied to a television, a laptop, a monitor, a billboard, or a display unit of the Internet of Things (IOT). As another example, the display apparatus 100 can be applied to a wearable device, such as a smart watch, a watch phone, a glasses-type display, and a head mounted display (HMD).

The display apparatus 100 can include a display panel 110, a scan driver 120, a display driver 130, a timing controller 140, and a power supply unit 150.

The display panel 110 can include a plurality of pixels SP that display an image. Each of the plurality of pixels SP can emit light from a light-emitting area or an opening area. For example, the display panel 110 can be a liquid crystal display panel or an organic light-emitting display panel, but is not limited thereto. The pixel SP can receive a scan signal from the scan driver 120 and a data voltage from the display driver 130 and emit light having luminance corresponding to the data voltage.

The scan driver 120 can generate scan signals based on a scan start pulse SSP, a scan clock SCLK, and a scan output enable signal SOE that are received from the timing controller 140. Here, the scan start pulse SSP can control the timing at which the scan driver 120 starts to operate. The scan clock SCLK can control the shift timing of the scan driver 120. The scan output enable signal SOE can control the output timing of the scan driver 120. The scan driver 120 can shift the scan signals using a shift register and sequentially supply the shifted scan signals to scan lines SL. The scan signals of the scan driver 120 can select pixels SP to which the data voltage is supplied, and the selected pixels SP can receive the data voltage through the data lines DL. The scan driver 120 can be disposed on one side or both sides of a non-display area NDA in a gate in panel (GIP) manner.

The display driver 130 can receive a data start pulse DSP, a data clock DCLK, and a data output enable signal DOE that are received from the timing controller 140. The data start pulse DSP can control the timing at which the display driver 130 starts to sample data. The data clock DCLK can control the timing at which the display driver 130 samples data. The data output enable signal DOE can control the output timing of the display driver 130.

The display driver 130 can receive first to third image data DATA1, DATA2, and DATA3 and convert the received image data into analog data voltages. The display driver 130 can convert one of the first to third image data DATA1, DATA2, and DATA3 into a data voltage according to the amount of change in a gaze position of a user. The display driver 130 can supply the data voltage of the selected image data to the data line DL. The display driver 130 can adjust the luminance of the pixels SP by outputting the data voltage according to the timing at which the scan signal is applied. The display driver 130 can be formed as an integrated circuit (IC). For example, the display driver 130 can be attached to one surface of a flexible film in a chip on film (COF) manner.

The timing controller 140 can receive source data SDATA and timing signals from an external host system 200. The timing signals can include a vertical synchronization signal Vsync, a horizontal synchronization signal Hsync, and a host clock signal HCLK. The timing controller 140 can generate the scan start pulse SSP, the scan clock SCLK, the scan output enable signal SOE, the data start pulse DSP, the data clock DCLK, and the data output enable signal DOE based on the timing signals. The timing controller 140 can supply the scan start pulse SSP, the scan clock SCLK, and the scan output enable signal SOE to the scan driver 120 according to timings implemented in a plurality of frames. The timing controller 140 can supply the data start pulse DSP, the data clock DCLK, and the data output enable signal DOE to the display driver 130 according to timings implemented in the plurality of frames. The timing controller 140 can receive the source data SDATA and generate the first to third image data DATA1, DATA2, and DATA3 according to the amount of change in the gaze position of the user. Here, first image data DATA1 can correspond to an image at a time point at which the amount of change in the gaze position of the user is relatively small, second image data DATA2 can correspond to an image at a time point at which the amount of change in the gaze position of the user is relatively medium, and third image data DATA3 can correspond to an image at a time point at which the amount of change in the gaze position of the user is relatively large. The timing controller 140 can supply the first to third image data DATA1, DATA2, and DATA3 to the display driver 130.

The power supply unit 150 can receive an input voltage Vin from the external host system 200. The power supply unit 150 can generate a power voltage necessary for driving the display panel 110, the scan driver 120, and the display driver 130 based on the input voltage Vin. Here, the power voltage can include a driving voltage EVDD, a low-potential voltage EVSS, an initialization voltage Vint, a reference voltage Vref, a bias voltage Vbias, a gate high voltage VGH, and a gate low voltage VGL, but is not limited thereto.

The host system 200 can be a portable electronic device, such as a mobile phone, a smart phone, a tablet personal computer (PC), a mobile communication terminal, an electronic notebook, an electronic book, a portable multimedia player (PMP), a navigation device, an ultra-mobile PC (UMPC), etc. For example, the host system 200 can be a television, a laptop, a monitor, a billboard, or an Internet Of Things (IOT) device. As another example, the host system 200 can be a wearable device, such as a smart watch, a watch phone, a glasses-type display, and a head mounted display (HMD).

The plurality of pixels SP can be connected to a scan line SL and a data line DL. Each of the plurality of pixels SP can include a pixel circuit and a light-emitting element. The pixel SP can supply a driving current according to a data voltage to the light-emitting element at a timing of receiving a scan signal and emit light.

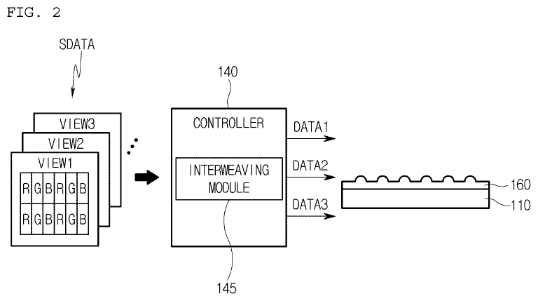

FIG. 2 is a view illustrating an operation conception of the display apparatus according to one embodiment of the present disclosure.

Referring to FIG. 2, the display apparatus 100 can include the display panel 110 having the plurality of pixels SP, the timing controller 140 for controlling the display panel 110, and an optical member 160 controlling a direction of light emitted from the display panel 110.

The optical member 160 can control the direction of light emitted from the display panel 110. For example, the optical member 160 can be a lens film, but is not limited thereto. The lens film can include a plurality of lenses and control a direction of incident light. Accordingly, the display apparatus 100 can display a three-dimensional image with different views. As another example, the optical member 160 can be a lenticular lens, a parallax barrier, or a microlens array.

The source data SDATA can be data of red (R), green (G), and blue (B) colors according to a plurality of views. The plurality of views can include first to third views VIEW1, VIEW2, and VIEW3. The source data SDATA can be image data acquired from a plurality of cameras at locations corresponding to the plurality of views or image data generated by three-dimensional modeling by a graphic processor.

The timing controller 140 can rearrange the source data SDATA received from the host system 200 through a rearrangement module 145 according to the light-emitting order and generate the first to third image data DATA1, DATA2, and DATA3 according to the amount of change in the gaze position of the user. The display panel 110 can receive the first to third image data DATA1, DATA2, and DATA3 and display a three-dimensional image.

For example, in case that the source data SDATA includes data of first to ninth views, the rearrangement module 145 can first display source data of odd views (data of first, third, fifth, seventh, and ninth views) among the source data SDATA and then display the data of even views (data of second, fourth, sixth, and eighth views). Alternatively, red image data of the same view among the source data SDATA can be extracted to correspond to two adjacent red pixels located in the same pixel row, and green image data of different views among the source data SDATA can be extracted to correspond to two adjacent green pixels located in the same pixel row. In addition, blue image data of the same view among the source data SDATA can be extracted to correspond to two adjacent blue pixels located in the same pixel row.

Accordingly, the rearrangement module 145 can mix the source data SDATA and arrange the mixed source data SDATA so that the user can recognize the three-dimensional image by the image data of different views displayed in the rearranged sequence. The sequence of the source data SDATA of multiple views rearranged by the rearrangement module 145 can be changed in various ways.

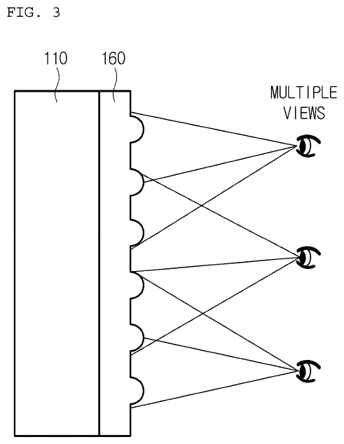

FIG. 3 is a view illustrating a user viewing an image in the display apparatus according to one embodiment of the present disclosure.

Referring to FIG. 3, the plurality of pixels SP of the display panel 110 can emit light of specific colors. A multi-view image can be generated by capturing an image of an object in different directions. Accordingly, the multi-view image can transmit multi-view information (e.g., an intensity, color, and direction of the image) to left and right eyes of the user, and the user can recognize a three-dimensional image.

The optical member 160 can be disposed on one surface of the display panel 110 to separate the image displayed on the display panel 110 and transmit different images to the left and right eyes of the user. In addition, the image information displayed on the display apparatus 100 can include direction information, and the user can recognize a three-dimensional image similar to a hologram.

The display apparatus 100 can eye-track the user's gaze using a camera and output an image selected from the first to third image data DATA1, DATA2, and DATA3 based on the gaze information of the user.

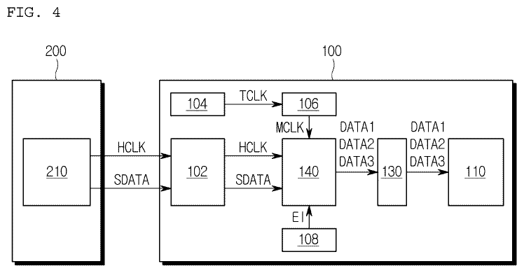

FIG. 4 is a block diagram illustrating a configuration that outputs image data based on gaze information of a user in the display apparatus according to one embodiment of the present disclosure.

Referring to FIG. 4, the host system 200 can include an interface transmitter 210, and the display apparatus 100 can include an interface receiver 102. The host system 200 and the display apparatus 100 can be connected by a high-speed data interface. The high-speed data interface can use a mobile industry processor interface (MIPI), but is not limited thereto. The MIPI is one of the serial interface standards for connecting a processor to peripheral devices and is the standard established by the MIPI Alliance. For example, an MIPI D-PHY is a high-speed digital serial interface, and an MIPI D-PHY DSI (display serial interface) corresponds to the D-PHY-based display protocol standard specification.

The host system 200 can transmit the host clock signal HCLK and the source data SDATA in the form of a differential signal in which positive and negative polarities are combined through the interface transmitter 210, and the interface receiver 102 of the display apparatus 100 can receive the host clock signal HCLK and the source data SDATA.

In the case of the MIPI, the host clock signal HCLK can generally vary within a range of 0.4 to 1.5 Gbps, and the source data SDATA of multiple views can be transmitted according to the host clock signal HCLK. In this case, the host system 200 can correspond to a master device that transmits the source data SDATA according to the MIPI interface standard, and the display apparatus 100 can correspond to a slave device that receives the source data SDATA from the host system 200 according to the MIPI standard.

The display apparatus 100 can include the interface receiver 102, the timing controller 140, an oscillator 104, a divider 106, a camera 108, and the display panel 110. The interface receiver 102 can transmit the host clock signal HCLK and the source data SDATA received from the interface transmitter 210 of the host system 200 to the timing controller 140.

The oscillator 104 can generate a system clock signal TCLK having a predetermined frequency (e.g., 110 MHz) to drive the display apparatus 100. The divider 106 can generate the main clock signal MCLK by dividing the system clock signal TCLK generated by the oscillator 104 at a predetermined ratio (e.g., 2-division, 3-division, or 4-division). The main clock signal MCLK can cover the host clock signal HCLK with a maximum range. For example, in case that the oscillator 104 generates the system clock signal TCLK with a frequency of 110 MHz, the divider 106 can generate a clock signal of 55 MHz, which is a 2-division clock signal of the system clock signal TCLK, and a clock signal of 37 MHz, which is a 3-division clock signal, and then re-divide each of the 2-division clock signal (55 MHz) and the 3-division clock signal (37 MHz) into 2, 4, 8 clock signals, etc. to generate the main clock signal MCLK having various frequencies. In this case, the main clock signal MCLK can have a frequency that becomes 2-division, 3-division, 4-division, 6-division, 8-division, 12-division, or higher of the system clock signal TCLK.

The timing controller 140 can arrange the source data SDATA transmitted from the host system 200 through the rearrangement module 145 and supply the main clock signal MCLK supplied through the divider 106 to the display panel 110. The main clock signal MCLK transmitted to the timing controller 140 through the divider 106 can be generated independently of the host clock signal HCLK transmitted from the host system 200 and can be divided into various frequencies.

The timing controller 140 can generate the first to third image data DATA1, DATA2, and DATA3 according to the amount of change in the gaze position of the user and supply the generated first to third image data DATA1, DATA2, and DATA3 to the display driver 130. The display driver 130 can convert one of the first to third image data DATA1, DATA2, and DATA3 into a data voltage according to the amount of change in a gaze position of a user. The display driver 130 can supply the data voltage of the selected image data to the data line DL.

The camera 108 can be disposed on one surface of the display apparatus 100 and can track the gaze of the user using the display apparatus 100 to generate gaze information EI. The timing controller 140 can calculate the gaze position, gaze movement direction, and gaze movement speed of the user using the gaze information EI of the user detected through the camera 108.

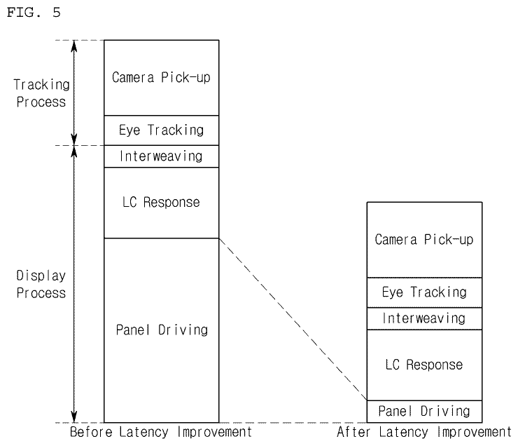

FIG. 5 is a view illustrating a latency of a displayed image based on the gaze information of the user in the display apparatus according to one embodiment of the present disclosure.

Referring to FIG. 5, the display apparatus 100 can reflect the gaze of the user and display an image by including a tracking process Tracking Process of detecting the gaze of the user through the camera 108, and a display process Display Process of displaying an image on the display panel 110 based on the gaze information of the user.

The tracking process can include a capturing section Camera Pick-up that captures the gaze of the user through the camera 108, and a tracking section Eye Tracking that tracks the gaze of the user through the captured image.

The display process can include a rearrangement section Interweaving that rearranges the source data SDATA, a liquid crystal section LC Response that a liquid crystal layer responses, and a driving section Panel Driving that drives the display panel 100. Here, the liquid crystal layer can be included in case that the display apparatus 100 is a liquid crystal display (LCD) apparatus and can be omitted in case that the display apparatus 100 is an organic light-emitting diode (OLED) display apparatus.

Before improving the latency Before Latency Improvement, the user can recognize crosstalk due to a latency from in case that the camera 108 detects the gaze of the user at the moment in case that an image of a specific line is displayed in an m^{th} frame (m is a positive integer) to in case that the synchronization of the image with the display panel 110 is newly initiated in an (m+1)th frame.

The display apparatus 100 can select one of the first to third image data DATA1, DATA2, and DATA3 by reflecting the amount of change in the gaze of the user in an (n+1)th line (n is a positive integer) after the camera 108 detects the gaze of the user at the moment in case that the image of the n^{th} line (n is a positive integer) is displayed in the m^{th} frame, thereby shortening the driving section Panel Driving as much as possible. Accordingly, in the display apparatus 100, it is possible to improve latency After Latency Improvement and prevent crosstalk.

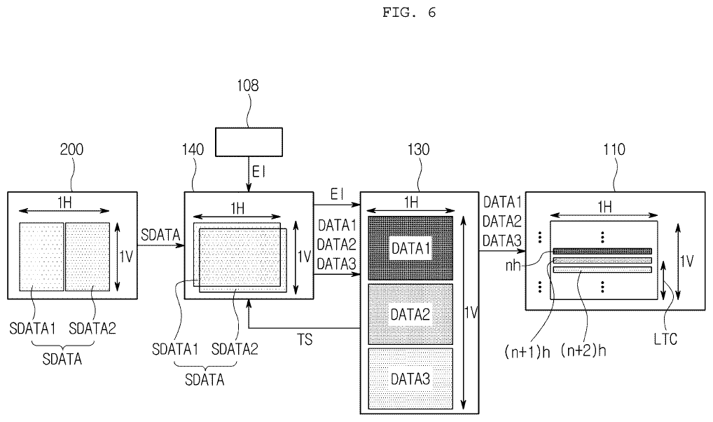

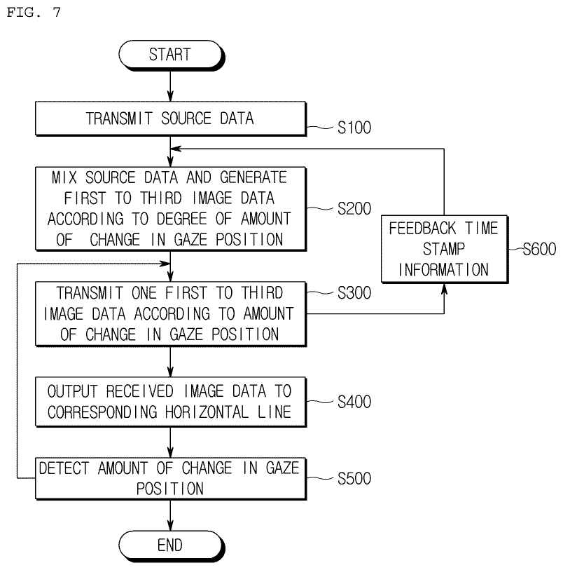

FIG. 6 is a block diagram illustrating the operation of the display apparatus according to one embodiment of the present disclosure, and FIG. 7 is a flowchart illustrating the operation of the display apparatus according to one embodiment of the present disclosure.

Referring to FIGS. 6 and 7, the host system 200 can generate a plurality of source data SDATA according to one frame or one vertical section (1V) and supply the plurality of source data SDATA to the timing controller 140 (operation S100). The source data SDATA corresponding to one vertical section 1V can include a plurality of source data SDATA corresponding to one horizontal line 1H. The source data SDATA can include first and second source data SDATA1 and SDATA2. The first source data SDATA1 can include image data transmitted to the left eye of the user, and the second source data SDATA2 can include image data transmitted to the right eye of the user. The first and second source data SDATA and SDATA2 can include multi-view information.

The timing controller 140 can mix the first and second source data SDATA1 and SDATA2 and generate the first to third image data DATA1, DATA2, and DATA3 according to the amount of change in the gaze position (operation S200). The timing controller 140 can set the scaling of the amount of change in the gaze position based on time stamp information TS received from the display driver 130. The timing controller 140 can set first and second references of the amount of change in the gaze position and generate the first to third image data DATA1, DATA2, and DATA3. The first image data DATA1 can correspond to a case in which the amount of change in the gaze position is less than the first reference, the second image data DATA2 can correspond to a case in which the amount of change in the gaze position is more than or equal to the first reference and less than the second reference, and the third image data DATA3 can correspond to a case in which the amount of change in the gaze position is more than or equal to the second reference. The timing controller 140 can generate three image data corresponding to one frame or one vertical section 1V and transmit the three image data to the display driver 130. The timing controller 140 can generate three image data at three times a rate of generating one image data corresponding to one frame.

The display driver 130 can transmit one of the first to third image data to the display panel 110 according to the amount of change in the gaze position of the horizontal line 1H (operation S300). For example, the display driver 130 can receive information indicating that the amount of change in the gaze position of the user is less than the first reference in an n^{th} horizontal line nh (n is a positive integer) and transmit the first image data DATA1 to the n^{th} horizontal line nh of the display panel 110. The display driver 130 can receive the amount of change in the gaze position of an (n+1)^{th} horizontal line (n+1)h after transmitting the first image data DATA1 to the n^{th} horizontal line nh. The display driver 130 can receive information indicating that the amount of change in the gaze position of the user in the (n+1)^{th} horizontal line (n+1)h is more than or equal to the first reference and less than the second reference and transmit the second image data DATA2 to the (n+1)^{th} horizontal line (n+1)h of the display panel 110. The display driver 130 can transmit the second image data DATA2 to the (n+1)^{th} horizontal line (n+1)h and then receive the amount of change in the gaze position of an (n+2)^{th} horizontal line (n+2)h. The display driver 130 can receive information indicating that the amount of change in the gaze position of the user is more than or equal to the second reference in the (n+2)^{th} horizontal line (n+2)h and transmit the third image data DATA3 to the (n+2)^{th} horizontal line (n+2)h of the display panel 110.

Accordingly, in case that the amount of change in the gaze position of the user is changed while the image data is transmitted to the horizontal line of the display panel 110, the display driver 130 can immediately transmit the image data corresponding to the changed amount of change in the gaze position to a next horizontal line. In case that the timing controller 140 generates one image data corresponding to one frame, in case that the amount of change in the gaze position is changed in a horizontal line in the middle of the display panel 110, the image data is not changed until the next frame, thereby causing a latency LTC. The display apparatus 100 can transmit one of the first to third image data DATA1, DATA2, and DATA3 based on the amount of change in the gaze position of the next horizontal line, thereby preventing the latency LTC of the display panel 110 and reducing tearing of the display panel 110.

The display panel 110 can output the image data received from the display driver 130 to the corresponding horizontal line (operation S400). The display panel 110 can display an image according to the first image data DATA1 on the n^{th} horizontal line nh, an image according to the second image data DATA2 on the (n+1)^{th} horizontal line (n+1)h, and an image according to the third image data DATA3 on the (n+2)^{th} horizontal line (n+2)h. The display panel 110 can output the image according to one of the first to third image data DATA1, DATA2, and DATA3 in response to the amount of change in the gaze position of the user on the basis of a horizontal line 1H. Accordingly, in the display apparatus 100, it is possible to reduce crosstalk due to the latency LTC between the time point at which the gaze of the user is detected and the time point at which the image is displayed on the display panel 110.

The timing controller 140 can detect the amount of change in the gaze position based on the gaze information EI (operation S500). The camera 108 can be disposed on one surface of the display apparatus 100 and can track the gaze of the user using the display apparatus 100 to generate the gaze information EI. The camera 108 can generate the gaze information EI for each horizontal line 1H of the display panel 110. The camera 108 can transmit the gaze information EI to the timing controller 140. The timing controller 140 can calculate the gaze position, gaze movement direction, and gaze movement speed of the user using the gaze information EI of the user. The timing controller 140 can supply the display driver 130 with the amount of change in the gaze position calculated based on the gaze information EI. The display driver 130 can reflect the amount of change in the gaze position received from the timing controller 140 in the next horizontal line.

The display driver 130 can feedback the time stamp information TS to the timing controller 140. The display driver 130 can receive the gaze information EI and the first to third image data DATA1, DATA2, and DATA3 from the timing controller 140. The time stamp information TS can include latency information, command execution information, and image processing feedback. For example, the time stamp information TS can include how much the amount of change in the gaze position was in which horizontal line of the display panel 110 and which image data among the first to third image data DATA1, DATA2, and DATA3 was selected and transmitted to the display panel 110.

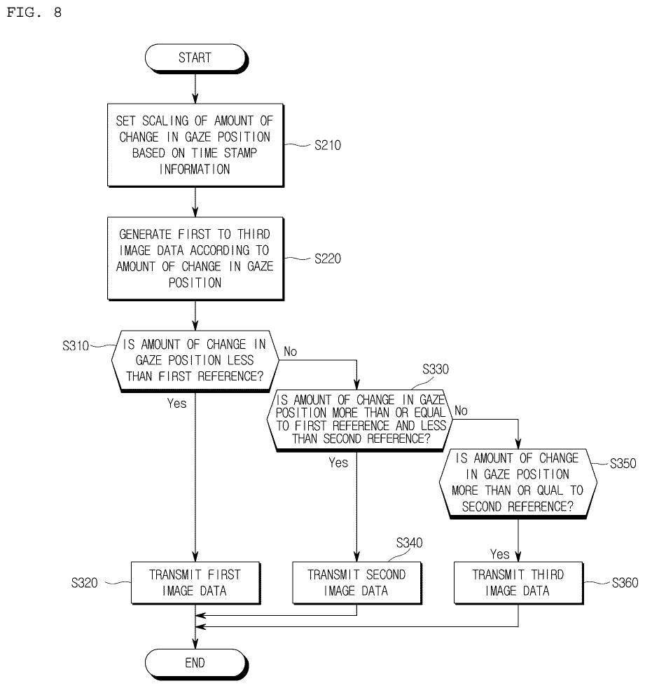

FIG. 8 is a flowchart illustrating a process of transmitting first to third image data in the display apparatus according to one embodiment of the present disclosure.

Referring to FIG. 8, the timing controller 140 can set a scaling range of the amount of change in the gaze position based on the time stamp information TS (operation S210). The timing controller 140 can receive the time stamp information TS as feedback from the display driver 130. The time stamp information TS can include latency information, command execution information, and image processing feedback. The scaling range of the amount of change in the gaze position can be set by increasing or decreasing the first and second references. In case that the amount of change in the gaze position relatively increases in the previous frame, the timing controller 140 can increase the first and second references of the amount of change in the gaze position applied to the next frame. In case that the amount of change in the gaze position relatively decreases in the previous frame, the timing controller 140 can decrease the first and second references of the amount of change in the gaze position applied to the next frame.

The timing controller 140 can set the first and second references of the amount of change in the gaze position and generate the first to third image data DATA1, DATA2, and DATA3 (operation S220). The timing controller 140 can generate three image data corresponding to one frame or one vertical section 1V and transmit the three image data to the display driver 130. The timing controller 140 can generate three image data at three times a rate of generating one image data corresponding to one frame.

The timing controller 140 can transmit information indicating that the amount of change in the gaze position of the n^{th} horizontal line nh is less than the first reference to the display driver 130 (operation S310). The display driver 130 can receive the information indicating that the amount of change in the gaze position of the user in the n^{th} horizontal line nh is less than the first reference and transmit the first image data DATA1 to the n^{th} horizontal line nh of the display panel 110 (operation S320).

The timing controller 140 can transmit information indicating that the amount of change in the gaze position of the (n+1)^{th} horizontal line (n+1)h is more than or equal to the first reference and less than the second reference to the display driver 130 (operation S330). The display driver 130 can receive the information indicating that the amount of change in the gaze position of the user in the (n+1)^{th} horizontal line (n+1)h is more than or equal to the first reference and less than the second reference and transmit the second image data DATA2 to the (n+1)^{th} horizontal line (n+1)h of the display panel 110 (operation S340).

The timing controller 140 can transmit information indicating that the amount of change in the gaze position of the (n+2)^{th} horizontal line (n+2)h is more than or equal to the second reference to the display driver 130 (operation S350). The display driver 130 can receive the information indicating that the amount of change in the gaze position of the user is more than or equal to the second reference in the (n+2)^{th} horizontal line (n+2)h and transmit the third image data DATA3 to the (n+2)^{th} horizontal line (n+2)h of the display panel 110 (operation S360).

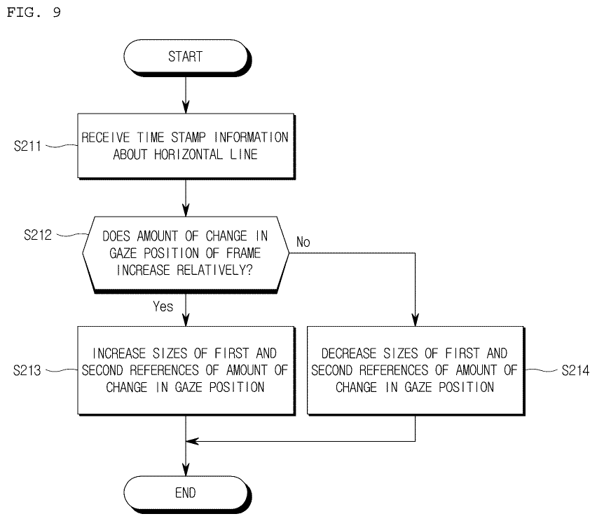

FIG. 9 is a flowchart illustrating a process of setting scaling of an amount of change in a gaze position in the display apparatus according to one embodiment of the present disclosure.

Referring to FIG. 9, the timing controller 140 can receive the time stamp information TS of the horizontal line 1H (operation S211).

In case that the amount of change in the gaze position relatively increases in the previous frame (operation S212), the timing controller 140 can increase the first and second references of the amount of change in the gaze position applied to the next frame (operation S213). In case that the amount of change in the gaze position relatively decreases in the previous frame (operation S212), the timing controller 140 can decrease the first and second references of the amount of change in the gaze position applied to the next frame (operation S214).

Accordingly, the timing controller 140 can change the scaling range of the amount of change in the gaze position for each frame and generate the first to third image data DATA1, DATA2, and DATA3 distinguished according to the first and second references of the amount of change in the gaze position in the corresponding frame. In case that the amount of change in the gaze position of the user is changed while the image data is transmitted to the horizontal line of the display panel 110, the display driver 130 can immediately transmit the image data corresponding to the changed amount of change in the gaze position to the next horizontal line. The display apparatus 100 can transmit one of the first to third image data DATA1, DATA2, and DATA3 based on the amount of change in the gaze position of the next horizontal line, thereby preventing the latency LTC of the display panel 110 and reducing tearing of the display panel 110.

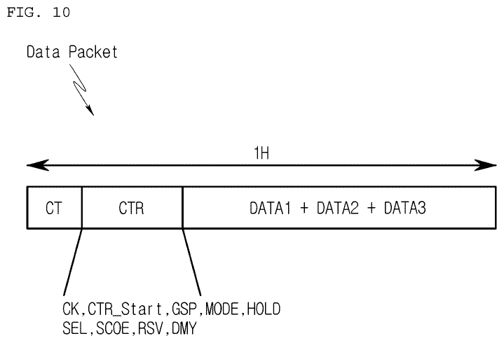

FIG. 10 is a view illustrating a data packet of the display apparatus according to one embodiment of the present disclosure.

Referring to FIG. 10, the timing controller 140 can transmit a data packet including the gaze information EI and the first to third image data DATA1, DATA2, and DATA3 to the display driver 130. The data packet can be generated in a data format satisfying the EPI interface protocol. The data packet can include a clock training signal CT, a control signal CTR, and the first to third image data DATA1, DATA2, and DATA3.

The clock training signal CT can be disposed in a header of the data packet and can include an identifier. The clock training signal CT can include information necessary for transmitting and identifying the data packet.

The control data signal CTR can include the timing signal, the control signal, and the gaze information EI. The control data signal CTR can include a clock signal CK, a control start signal CTR Start, a gate start pulse GSP, a mode signal MODE, a hold signal HOLD, a selection signal SEL, a source output enable SCOE, a reservation signal RSV, and a dummy signal DMY. The gaze information EI can be included in the reservation signal RSV and transmitted to the display driver 130. The clock training signal CT and the control signal CTR can be transmitted in a vertical blank period and a horizontal blank period.

The first to third image data DATA1, DATA2, and DATA3 can be transmitted in a period excluding the horizontal blank period from one horizontal period. The timing controller 140 can generate three image data corresponding to one frame or one vertical section 1V and transmit the three image data for each horizontal line 1H. One of the three image data can be selected by the display driver 130 for each horizontal line 1H.

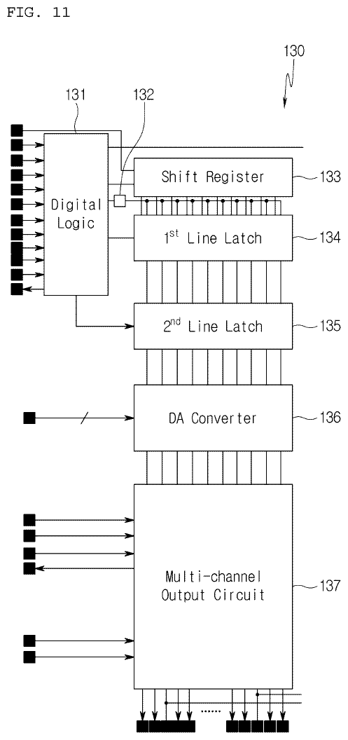

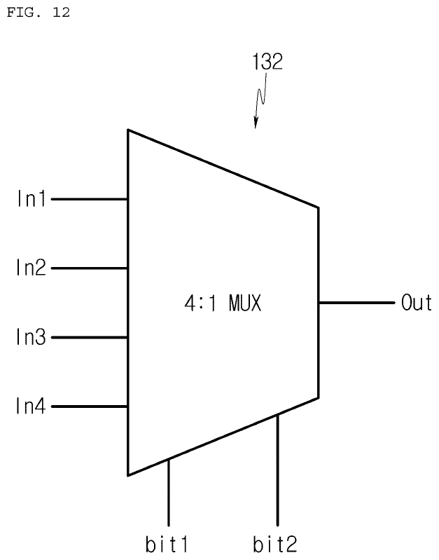

FIG. 11 is a block diagram illustrating a display driver of the display apparatus according to one embodiment of the present disclosure, and FIG. 12 is a view illustrating a data selector of the display driver in the display apparatus according to one embodiment of the present disclosure.

Referring to FIGS. 11 and 12, the display driver 130 can include a digital logic 131, a data selector 132, a shift register 133, a first line latch 134, a second line latch 135, a digital-to-analog converter 136, and a multi-channel output circuit 137.

The digital logic 131 can calculate an input signal and supply the calculated input signal to the data selector 132, the shift register 133, the first line latch 134, and the second line latch 135.

The data selector 132 can receive first and second bits bit1 and bit2 and output one of first to fourth input signals In1, In2, In3, and In4. For example, the first to third input signals In1, In2, and In3 can include the first to third image data DATA1, DATA2, and DATA3, and the fourth input signal may not have a data value. The data selector 132 can be a 4:1 multiplexer MUX, but is not limited thereto.

The first line latch 134 can receive signals of the data selector 132 and the shift register 133 and transmit output values to the second line latch 135.

The second line latch 135 can receive signals of the digital logic 131 and the first line latch 134 and transmit output values to the digital-to-analog converter 136.

The digital-to-analog converter 136 can receive input signals and signals of the second line latch 135 and transmit output values to the multi-channel output circuit 137.

The multi-channel output circuit 137 can receive the input signals and the signals of the digital-to-analog converter 136 and supply a data voltage corresponding to one of the first to third image data DATA1, DATA2, and DATA3.

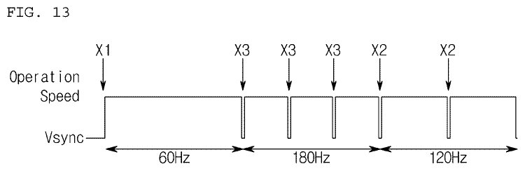

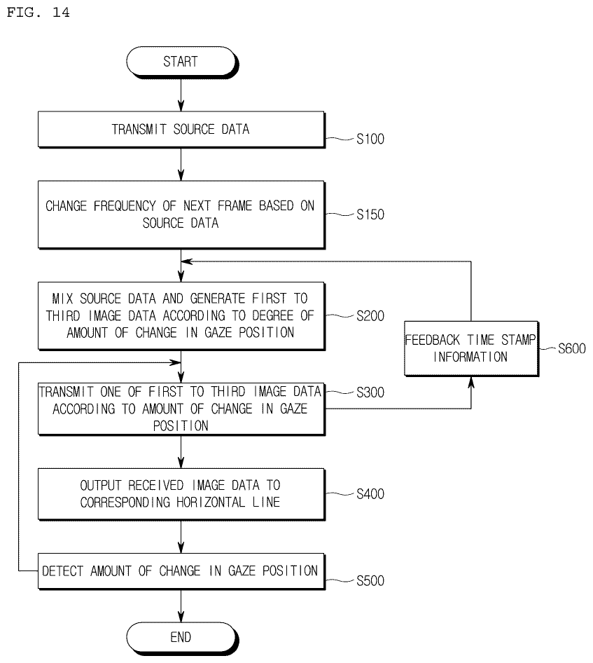

FIG. 13 is a view illustrating a change in a driving frequency based on gaze information of a user in a display apparatus according to another embodiment of the present disclosure, and FIG. 14 is a flowchart illustrating the operation of the display apparatus according to another embodiment of the present disclosure. The display apparatus of FIGS. 13 and 14 further include a frequency change operation in the display apparatus of FIGS. 6 and 7, and the same configuration as the above configuration will be briefly described or omitted.

Referring to FIGS. 13 and 14, the host system 200 can generate a plurality of source data SDATA according to one frame or one vertical section 1V and supply the plurality of source data SDATA to the timing controller 140 (operation S100).

The timing controller 140 can change a frequency of the next frame based on the source data SDATA (operation S150). The timing controller 140 can increase the frequency of the next frame in case that an image change rate of the source data SDATA increases. The timing controller 140 can decrease the frequency of the next frame in case that the image change rate of the source data SDATA decreases. Here, the case in which the image change rate increases can correspond to a case in which the content of the image varies quickly and the amount of change in the gaze position of the user can increase. The timing controller 140 can increase the frequency by decreasing a cycle of the vertical synchronization signal Vsync. For example, in case that the image change rate of the source data SDATA increases compared to the previous frame driven at the frequency of 60 Hz, the timing controller 140 can increase the frequency of the next frame to 180 Hz by increasing the operation speed by three times. In case that the image change rate of the source data SDATA decreases compared to the previous frame driven at the frequency of 180 Hz, the timing controller 140 can decrease the frequency of the next frame to 120 Hz by decreasing the operation speed. Accordingly, the display apparatus 100 can adjust the driving frequency by reflecting the amount of change in the gaze position of the user in advance based on the source data SDATA and prevent the latency LTC of the display panel 110 and reduce crosstalk.

The timing controller 140 can mix the first and second source data SDATA1 and SDATA2 and generate the first to third image data DATA1, DATA2, and DATA3 according to the amount of change in the gaze position (operation S200).

The display driver 130 can transmit one of the first to third image data to the display panel 110 according to the amount of change in the gaze position of the horizontal line 1H (operation S300).

The display panel 110 can output the image data received from the display driver 130 to the corresponding horizontal line (operation S400).

The timing controller 140 can detect the amount of change in the gaze position based on the gaze information EI (operation S500).

The display driver 130 can feedback the time stamp information TS to the timing controller 140.

The display apparatus 100 according to various embodiments of the present disclosure can be described as follows.

According to various embodiments of the present disclosure, there is provided a display apparatus including a display panel including pixels arranged in a plurality of horizontal lines, a camera configured to capture a gaze of a user, a timing controller configured to receive source data and timing signals from a host system, receive gaze information from the camera, and generate first to third image data according to a degree of an amount of change in a gaze position, and a display driver configured to receive the amount of change in the gaze position and the first to third image data and transmit one of the first to third image data to the display panel according to the amount of change in the gaze position of each of a plurality of horizontal lines.

In the display apparatus according to various embodiments of the present disclosure, the display driver can transmit one of the first to third image data to an n^{th} horizontal line (n is a positive integer) of the display panel and receive an amount of change in a gaze position of an (n+1)^{th} horizontal line.

In the display apparatus according to various embodiments of the present disclosure, the camera can track the gaze of the user, generate gaze information, and transmit the generated gaze information to the timing controller, and the timing controller can calculate the amount of change in the gaze position for each of the plurality of horizontal lines using the gaze information and transmit the amount of change in the gaze position to the display driver.

In the display apparatus according to various embodiments of the present disclosure, the display driver can feedback time stamp information corresponding to each of the plurality of horizontal lines to the timing controller, and the time stamp information can include the amount in change of the gaze position and image data information selected according to the amount of change in the gaze position among the first to third image data for each of the plurality of horizontal lines.

In the display apparatus according to various embodiments of the present disclosure, the timing controller can set a scaling range of the amount of change in the gaze position based on the time stamp information.

In the display apparatus according to various embodiments of the present disclosure, the timing controller can generate the first to third image data corresponding to one frame based on first and second references of the amount of change in the gaze position set along the scaling range.

In the display apparatus according to various embodiments of the present disclosure, the timing controller can generate the first image data corresponding to a case in which the amount of change in the gaze position is less than the first reference, generate the second image data corresponding to a case in which the amount of change in the gaze position is more than or equal to the first reference and less than the second reference, and generate the third image data corresponding to a case in which the amount of change in the gaze position is more than or equal to the second reference.

In the display apparatus according to various embodiments of the present disclosure, the display driver can transmit the first image data to the display panel in case that the amount of change in the gaze position of a next horizontal line is less than the first reference, transmit the second image data corresponding to a case in which the amount of change in the gaze position of the next horizontal line is more than or equal to the first reference and less than the second reference to the display panel, and transmit the third image data corresponding to a case in which the amount of change in the gaze position of the next horizontal line is more than or equal to the second reference to the display panel.

In the display apparatus according to various embodiments of the present disclosure, the timing controller can increase the first and second references of the amount of change in the gaze position applied to the next frame in case that the amount of change in the gaze position of a next frame relatively increases and decrease the first and second references of the amount of change in the gaze position applied to the next frame in case that the amount of change in the gaze position of the next frame relatively decreases.

In the display apparatus according to various embodiments of the present disclosure, the display driver can include a multiplexer configured to receive a 2-bit signal and outputs one of the first to third image data.

In the display apparatus according to various embodiments of the present disclosure, the timing controller can change a frequency of the next frame based on the source data.

In the display apparatus according to various embodiments of the present disclosure, the timing controller can increase the frequency of the next frame in case that an image change rate of the source data increases and decrease the frequency of the next frame in case that the image change rate of the source data decreases.

According to various embodiments of the present disclosure, there is provided a display apparatus including a display panel including pixels arranged in first and second horizontal lines, a camera configured to capture a gaze of a user, a timing controller configured to receive source data for an m^{th} frame (m is a positive integer) from a host system, receive gaze information from the camera, and generate first to third image data for the m^{th} frame according to a degree of an amount of change in a gaze position, and a display driver configured to receive the first to third image data at a start stage of the m^{th} frame, receive an amount of change in a gaze position of the first horizontal line at a start stage of the first horizontal line, transmit one of the first to third image data to the display panel according to the amount of change in the gaze position of the first horizontal line, receive an amount of change in a gaze position of the second horizontal line at a start stage of the second horizontal line, and transmit one of the first to third image data to the display panel according to the amount of change in the gaze position of the second horizontal line.

In the display apparatus according to various embodiments of the present disclosure, the display driver can feedback time stamp information corresponding to each of the first and second horizontal lines to the timing controller, and the time stamp information can include the amount of change in the gaze position and image data information selected according to the amount of change in the gaze position among the first to third image data for each of the first and second horizontal lines.

In the display apparatus according to various embodiments of the present disclosure, the timing controller can set a scaling range of the amount of change in the gaze position based on the time stamp information.

In the display apparatus according to various embodiments of the present disclosure, the timing controller can generate first to third image data corresponding to an (m+1)^{th} frame based on first and second references of the amount of change in the gaze position set according to the scaling range.

In the display apparatus according to various embodiments of the present disclosure, the timing controller can generate the first image data corresponding to a case in which the amount of change in the gaze position is less than the first reference, generate the second image data corresponding to a case in which the amount of change in the gaze position is more than or equal to the first reference and less than the second reference, and generate the third image data corresponding to a case in which the amount of change in the gaze position is more than or equal to the second reference.

In the display apparatus according to various embodiments of the present disclosure, the display driver can transmit the first image data to the display panel in case that the amount of change in the gaze position of the first horizontal line is less than the first reference, transmit the second image data corresponding to a case in which the amount of change in the gaze position of the first horizontal line is more than or equal to the first reference and less than the second reference, and transmit the third image data corresponding to a case in which the amount of change in the gaze position of the first horizontal line is more than or equal to the second reference to the display panel.

In the display apparatus according to various embodiments of the present disclosure, the timing controller can increase the first and second references of the amount of change in the gaze position applied to an (m+1)^{th} frame in case that the amount of change in the gaze position of the (m+1)^{th} frame relatively increases and decrease the first and second references of the amount of change in the gaze position applied to the (m+1)^{th} frame in case that the amount of change in the gaze position of the (m+1)^{th} frame relatively decreases.

In the display apparatus according to various embodiments of the present disclosure, the timing controller can increase a frequency of the (m+1)^{th} frame in case that an image change rate of the source data increases and decrease the frequency of the (m+1)^{th} frame in case that the image change rate of the source data decreases.

According to the display apparatus according to the embodiments of the present disclosure, by transmitting one image data among the plurality of image data based on the amount of change in the gaze position of the next horizontal line, it is possible to prevent the latency of the display panel and reduce tearing and crosstalk.

According to the display apparatus according to the embodiments of the present disclosure, by transmitting one image data among the plurality of image data based on the amount of change in the gaze position of the next horizontal line, it is possible to improve reliability and reduce power consumption.

However, effects obtainable from the present disclosure are not limited to the above-described effects, and other effects that are not mentioned will be able to be clearly understood by those skilled in the art to which the present disclosure pertains based on the following description.

Although one embodiment has been described above with reference to the accompanying drawings, those skilled in the art to which the disclosure pertains will be able to understand that the above-described technical configuration of the present invention can be carried out in other specific forms without changing the technical spirit or essential features thereof. Accordingly, it should be understood that the above-described embodiments are illustrative and not restrictive in all respects. In addition, the scope of the disclosure is described by the claims to be described below rather than the detailed description. In addition, the meaning and scope of the claims and all changed or modified forms derived from the equivalent concept should be construed as being included in the scope of the present disclosure.

### DESCRIPTION OF REFERENCE NUMERALS

| | |
|---|---|
| 100: display apparatus | 110: display panel |
| 120: scan driver | 130: display driver |
| 140: timing controller | 150: power supply unit |
| 108: camera | 200: host system |

What is claimed is:

1. A display apparatus comprising:
a display panel including pixels arranged in a plurality of horizontal lines;
a camera configured to capture a gaze of a user;
a timing controller configured to receive source data and timing signals from a host system, receive gaze information from the camera, and generate first to third image data according to a degree of an amount of change in a gaze position; and
a display driver configured to receive the amount of change in the gaze position and the first to third image data and transmit one of the first to third image data to the display panel according to the amount of change in the gaze position of each of a plurality of horizontal lines.

2. The display apparatus of claim 1, wherein the display driver transmits one of the first to third image data to an n^{th} horizontal line of the display panel and receives an amount of change in a gaze position of an (n+1)^{th} horizontal line, where n is a positive integer.

3. The display apparatus of claim 2, wherein the camera tracks the gaze of the user, generates gaze information, and transmits the generated gaze information to the timing controller, and
the timing controller calculates the amount of change in the gaze position for each of the plurality of horizontal lines using the gaze information and transmits the amount of change in the gaze position to the display driver.

4. The display apparatus of claim 1, wherein the display driver feeds back time stamp information corresponding to each of the plurality of horizontal lines to the timing controller, and
the time stamp information includes the amount in change of the gaze position and image data information selected according to the amount of change in the gaze position among the first to third image data for each of the plurality of horizontal lines.

5. The display apparatus of claim 4, wherein the timing controller sets a scaling range of the amount of change in the gaze position based on the time stamp information.

6. The display apparatus of claim 5, wherein the timing controller generates the first to third image data corresponding to one frame based on first and second references of the amount of change in the gaze position set along the scaling range.

7. The display apparatus of claim 6, wherein the timing controller generates the first image data corresponding to a case in which the amount of change in the gaze position is less than the first reference,
the timing controller generates the second image data corresponding to a case in which the amount of change in the gaze position is more than or equal to the first reference and less than the second reference, and
the timing controller generates the third image data corresponding to a case in which the amount of change in the gaze position is more than or equal to the second reference.

8. The display apparatus of claim 6, wherein the display driver transmits the first image data to the display panel when the amount of change in the gaze position of a next horizontal line is less than the first reference,
the display driver transmits the second image data corresponding to a case in which the amount of change in the gaze position of the next horizontal line is more than or equal to the first reference and less than the second reference to the display panel, and
the display driver transmits the third image data corresponding to a case in which the amount of change in the gaze position of the next horizontal line is more than or equal to the second reference to the display panel.

9. The display apparatus of claim 5, wherein the timing controller increases the first and second references of the amount of change in the gaze position applied to the next frame when the amount of change in the gaze position of a next frame relatively increases, and
the timing controller decreases the first and second references of the amount of change in the gaze position applied to the next frame when the amount of change in the gaze position of the next frame relatively decreases.

10. The display apparatus of claim 1, wherein the display driver includes a multiplexer configured to receive a 2-bit signal and outputs one of the first to third image data.

11. The display apparatus of claim 1, wherein the timing controller changes a frequency of the next frame based on the source data.

12. The display apparatus of claim 11, wherein the timing controller increases the frequency of the next frame when an image change rate of the source data increases, and decreases the frequency of the next frame when the image change rate of the source data decreases.

13. A display apparatus comprising:
a display panel including pixels arranged in first and second horizontal lines;
a camera configured to capture a gaze of a user;
a timing controller configured to receive source data for an m^{th} frame from a host system, receive gaze information from the camera, and generate first to third image data for the m^{th} frame according to a degree of an amount of change in a gaze position, where m is a positive integer; and
a display driver configured to receive the first to third image data at a start stage of the m^{th} frame, receive an amount of change in a gaze position of the first horizontal line at a start stage of the first horizontal line, transmit one of the first to third image data to the display panel according to the amount of change in the gaze position of the first horizontal line, receive an amount of change in a gaze position of the second horizontal line at a start stage of the second horizontal line, and transmit one of the first to third image data to the display panel according to the amount of change in the gaze position of the second horizontal line.

14. The display apparatus of claim 13, wherein the display driver feeds back time stamp information corresponding to each of the first and second horizontal lines to the timing controller, and
the time stamp information includes the amount of change in the gaze position and image data information selected according to the amount of change in the gaze position among the first to third image data for each of the first and second horizontal lines.

15. The display apparatus of claim 14, wherein the timing controller sets a scaling range of the amount of change in the gaze position based on the time stamp information.

16. The display apparatus of claim 15, wherein the timing controller generates first to third image data corresponding to an (m+1)^{th} frame based on first and second references of the amount of change in the gaze position set according to the scaling range.

17. The display apparatus of claim 16, wherein the timing controller generates the first image data corresponding to a case in which the amount of change in the gaze position is less than the first reference,
the timing controller generates the second image data corresponding to a case in which the amount of change in the gaze position is more than or equal to the first reference and less than the second reference, and
the timing controller generates the third image data corresponding to a case in which the amount of change in the gaze position is more than or equal to the second reference.

18. The display apparatus of claim 16, wherein the display driver transmits the first image data to the display panel when the amount of change in the gaze position of the first horizontal line is less than the first reference,
the display driver transmits the second image data corresponding to a case in which the amount of change in the gaze position of the first horizontal line is more than or equal to the first reference and less than the second reference, and
the display driver transmits the third image data corresponding to a case in which the amount of change in the gaze position of the first horizontal line is more than or equal to the second reference to the display panel.

19. The display apparatus of claim 16, wherein the timing controller increases the first and second references of the amount of change in the gaze position applied to an (m+1)^{th} frame when the amount of change in the gaze position of the (m+1)^{th} frame relatively increases, and
the timing controller decreases the first and second references of the amount of change in the gaze position applied to the (m+1)^{th} frame when the amount of change in the gaze position of the (m+1)^{th} frame relatively decreases.

20. The display apparatus of claim 13, wherein the timing controller increases a frequency of the (m+1)^{th} frame when an image change rate of the source data increases, and decreases the frequency of the (m+1)^{th} frame when the image change rate of the source data decreases.
